(19) United States
(12) Patent Application Publication
(10) Pub. No.: US 2008/0304212 A1
(43) Pub. Date: Dec. 11, 2008

(54) SYSTEM AND METHOD OF ENABLING POWER OUTPUT FROM A POWER PEDESTAL

(76) Inventors: Paul D. SEFF, Williamsburg, VA (US); Alston G. Brooks, Grafton, VA (US); Gregory S. Nailler, Providence Forge, VA (US)

Correspondence Address: Martin J. Moran;Eaton Electrical, Inc., Technology & Quality Center, 170 Industry Drive, RIDC Park West, Pittsburgh, PA, 15275-1032, US

(21) Appl. No.: 11/759,689

(22) Filed: Jun. 7, 2007

(51) Int. Cl. H02B 1/50

(52) U.S. Cl. 361/659; 705/39

(57) ABSTRACT

A system enables power output from a power pedestal. The system includes a number of power pedestals, a card reader structured to receive credit or debit card information from a credit or debit card, and a first interface to another system structured to approve a transaction based upon the credit or debit card information. A processor cooperates with the card reader and the first interface to initiate and receive approval of the transaction from the other system. A user interface device cooperates with the processor to input a time duration to power one of the number of power pedestals responsive to the received approval. A second interface to the number of power pedestals cooperates with the processor and is structured to enable power output from such one of the number of power pedestals for the inputted time duration.

### BACKGROUND OF THE INVENTION

1. Field of the Invention

This invention pertains generally to systems and methods employing a number of power pedestals and, more particularly, to such systems and methods employing, for example, vehicle or marina power pedestals.

2. Background Information

U.S. Pat. No. 6,844,716 discloses a utility distribution pedestal for marine and recreational vehicles.

It is known to provide prepayment authorization at a power pedestal where a user's credit information is entered on a transponder, which authorizes use of and payment for electricity from the power pedestal. Such known power pedestals employ electricity meters that measure and display power or energy consumption. Other known power pedestals display a user's electricity consumption through local metering of such power or energy consumption, without prepayment authorization or remote metering. It is believed that a receipt showing the actual charge to the user is provided after the user is finished using the power pedestal and the total power or energy consumption has been measured.

There is room for improvement in systems and methods employing power pedestals.

### SUMMARY OF THE INVENTION

This need and others are met by embodiments of the invention, which provide a system and a method that enable power output from a power pedestal for a time duration that is input by the user. This simplifies the billing of the user, since no local or remote electricity meter is required. Furthermore, the user may receive a receipt for the corresponding charge after entry of the desired time duration, since the billed amount is proportional to the time that the power output is enabled as opposed to being based upon the actual power or energy from the power pedestal.

In accordance with one aspect of the invention, a system for enabling power output from a power pedestal comprises: a number of power pedestals; a processor; a user interface device cooperating with the processor to input a time duration to power one of the number of power pedestals; and an interface to the number of power pedestals, the interface cooperating with the processor and being structured to enable power output from such one of the number of power pedestals for the inputted time duration.

The processor may comprise a timer and a routine. The routine may be structured to initialize the timer with the inputted time duration. The timer may be structured to expire after the inputted time duration has elapsed. The routine may be further structured to responsively disable the power output from such one of the number of power pedestals after the timer has expired.

As another aspect of the invention, a system for enabling power output from a power pedestal comprises: a number of power pedestals; a card reader structured to receive credit or debit card information from a credit or debit card; a first interface to another system structured to approve a transaction based upon the credit or debit card information; a processor cooperating with the card reader and the first interface to initiate and receive approval of the transaction from such another system; a user interface device cooperating with the processor to input a time duration to power one of the number of power pedestals responsive to the received approval; and a second interface to the number of power pedestals, the second interface cooperating with the processor and being structured to enable power output from such one of the number of power pedestals for the inputted time duration.

Such one of the number of power pedestals may comprise an indicator structured to indicate when the power output from such one of the number of power pedestals is enabled.

The user interface device may comprise a display and a user input device. The display and the user input device may cooperate to enable a user to input the time duration and to display the inputted time duration.

As another aspect of the invention, a method of enabling power output from a power pedestal comprises: employing a number of power pedestals; inputting a time duration to power one of the number of power pedestals; and enabling power output from such one of the number of power pedestals for only the inputted time duration.

### BRIEF DESCRIPTION OF THE DRAWINGS

A full understanding of the invention can be gained from the following description of the preferred embodiments when read in conjunction with the accompanying drawings in which:

FIGS. 1A-1B form a block diagram of a system for enabling power output from a power pedestal in accordance with embodiments of the invention.

FIG. 2 is a flowchart of a routine executed by the processor of FIG. 1A.

FIG. 3 is a block diagram of a system for enabling power output from a power pedestal in accordance with another embodiment of the invention.

### DESCRIPTION OF THE PREFERRED EMBODIMENTS

As employed herein, the term “vehicle” shall expressly include, but not be limited by, a land vehicle, a marine vehicle, an air vehicle or another motor vehicle.

As employed herein, the term “land vehicle” shall expressly include, but not be limited by, any land-based vehicles having pneumatic tires, any rail-based vehicles, any maglev vehicles, automobiles, cars, trucks, station wagons, sport-utility vehicles (SUVs), recreational vehicles (RVs), construction vehicles, off road vehicles, all-terrain vehicles, farm vehicles, fleet vehicles, motor homes, vans, buses, motorcycles, mopeds, campers, trailers, or bicycles.

As employed herein, the term “marine vehicle” shall expressly include, but not be limited by, any water-based vehicles, ships, boats, other vessels for travel on water, submarines, or other vessels for travel under water.

As employed herein, the term “air vehicle” shall expressly include, but not be limited by, any air-based vehicles, airplanes, jets, aircraft, airships, balloons, blimps, or dirigibles.

As employed herein, the term “number” shall mean one or an integer greater than one (i.e., a plurality).

As employed herein, the term “platform” shall mean a horizontal flat surface, a raised horizontal flat surface, or a dock pier.

As employed herein, the term “pedestal” or “pedestal member” shall mean an elongated, generally upright structure.

As employed herein, the term “power pedestal” shall mean a pedestal or pedestal member structured to input power from input power terminals (e.g., utility power terminals) and output power to a number of power output receptacles.

As employed herein, the term “processor” means a programmable analog and/or digital device that can store, retrieve, and process data; a computer; a workstation; a personal computer; a microprocessor; a microcontroller; a microcomputer; a central processing unit; a mainframe computer; a mini-computer; a server; a networked processor; or any suitable processing device or apparatus.

The invention is described in association with a system for enabling power output from one of a plurality of power pedestals, although the invention is applicable to any number of power pedestals.

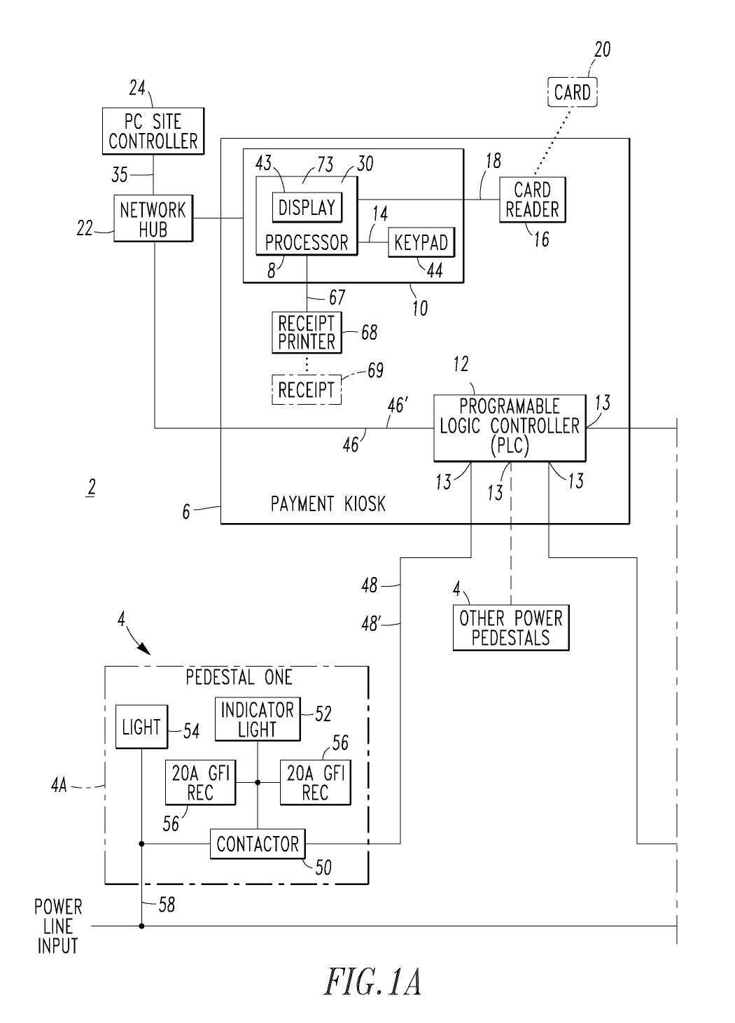

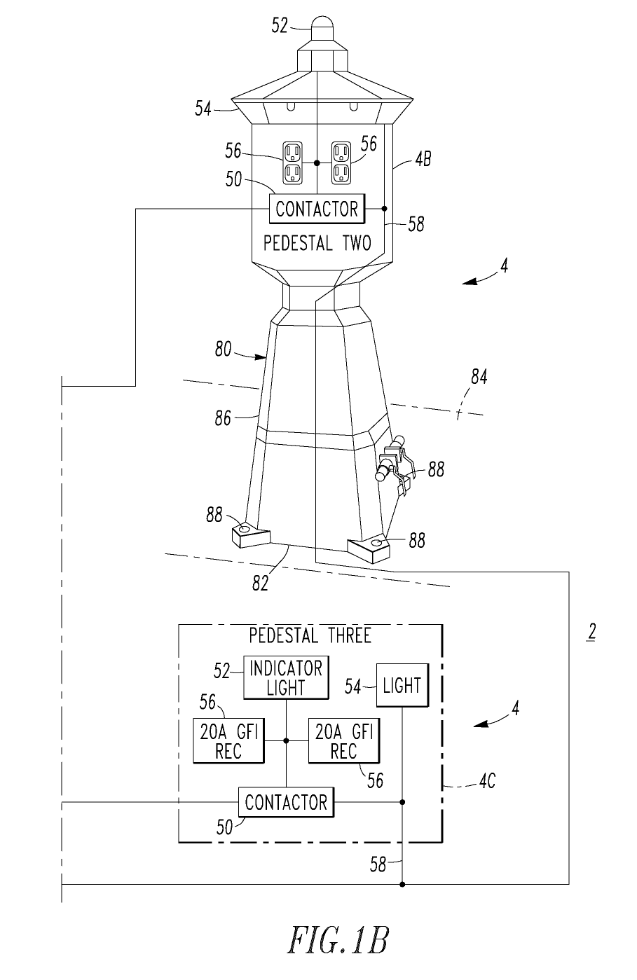

Referring to FIGS. 1A-1B, system 2 includes a number of power pedestals 4 (e.g., although three power pedestals 4A,4B,4C are shown, one, two, four or more power pedestals may be employed) and a payment kiosk 6. The payment kiosk 6 includes a processor 8, a user interface device 10 and a suitable interface to the power pedestals 4, such as the example programmable logic controller (PLC) 12 including a plurality of outputs 13, one for each of the example power pedestals 4.

As will be discussed, the user interface device 10 cooperates with the processor 8 to input a time duration 14 to power one of power pedestals 4, such as 4A. The PLC 12 cooperates with the processor 8 and is structured to enable power output from, for example, such power pedestal 4A for the inputted time duration 14.

### EXAMPLE 1

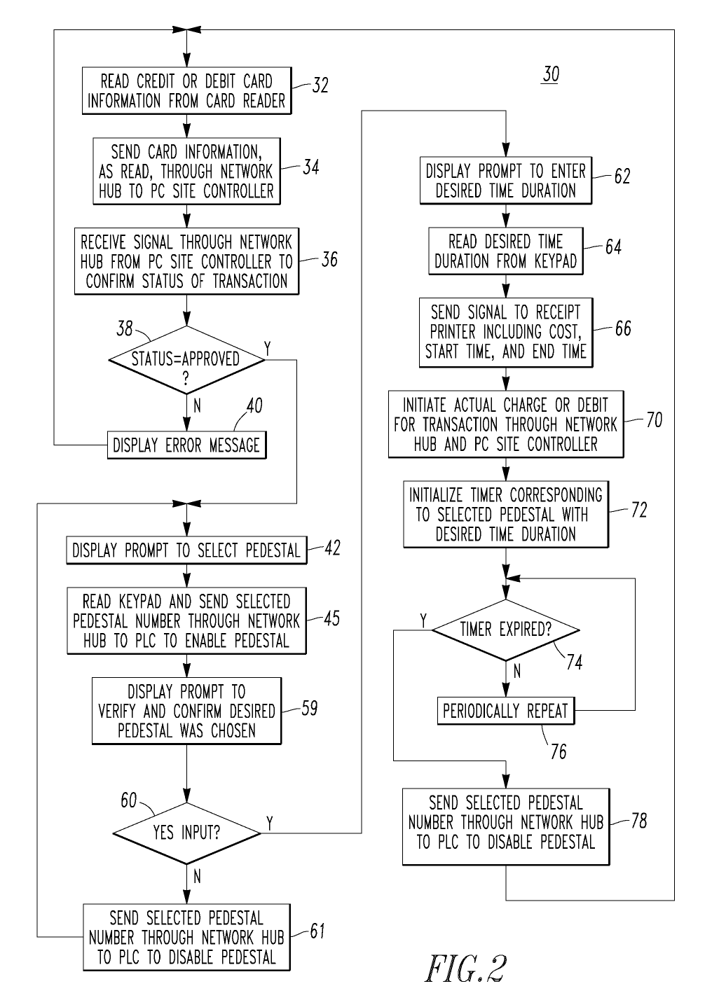

The example kiosk 6 includes a card reader 16 cooperating with the processor 8 and structured to receive credit or debit card information 18 from a credit or debit card 20 (shown in phantom line drawing), in a well known manner. The processor 8 has a first interface through a network hub 22 to another system, such as a suitable processor, for example, the personal computer (PC) site controller 24, which is structured to approve a transaction based upon the credit or debit card information 18. The processor 8 cooperates with the card reader 16 and the network hub 22 to initiate and receive approval of the transaction from the PC site controller 24. As will be described, below, in connection with FIG. 2, after the transaction is approved, the user interface device 10 cooperates with the processor 8 to input the time duration 14 responsive to the approval of the transaction. In turn, the PLC 12 forms a second interface, cooperates with the processor 8 and enables power output from one of the power pedestals (e.g., 4A) for only the inputted time duration 14. In this manner, the system 2 can provide power to a user (not shown) for a price that is a function of the total time that the corresponding power pedestal 4 is enabled to provide power to that user. This simplifies the process for the user since there is a single transaction that both enables power from the corresponding power pedestal 4 and charges the user for use of that power pedestal. Hence, when the user is ready to depart from the corresponding power pedestal 4 (e.g., without limitation, drive a car away from a land vehicle power pedestal; pilot a boat away from a marine vehicle power pedestal), the user can simply do so without having to stop and pay the proprietor of the system 2 for that use.

### EXAMPLE 2

Referring to FIG. 2, a flowchart of a routine 30 executed by the processor 8 of FIG. 1A is shown. Initially, a user swipes the credit or debit card 20 at the card reader 16 of the payment kiosk 6. At 32, the processor 8 reads the credit or debit card information 18 from the card reader 16. Next, at 34, the processor 8 sends the card information 18, as read, through the network hub 22 to the site controller 24 (e.g., without limitation, a suitable processor, such as a PC or server). The site controller 24, then, in a well known manner, responsively verifies the card information 18, approves the credit or debit transaction (e.g., without limitation, via the Internet (not shown)), and sends a signal 35 back to the processor 8 through the network hub 22 to confirm the status of the transaction (e.g., approved; denied). Then, at 36, the processor 8 receives the signal 35.

Next, at 38, if the status of the transaction was denied, then a suitable error message is displayed at 40, and step 32 is repeated. On the other hand, if the status of the transaction was approved, then, at 42, the processor 8 displays a prompt on a display 43 for the user to select which of the various power pedestals 4 will be used. Although three example power pedestals 4A,4B,4C are shown, the invention is applicable to any suitable number of power pedestals 4 (e.g., one; two; three; four or more power pedestals). In response to the prompt, the user selects the power pedestal number (or other suitable indicia) via a keypad 44. Next, at 45, the processor 8 reads the keypad 44 and responsively sends a signal 46 including the selected power pedestal number (or other suitable indicia) through the network hub 22 to the PLC 12. Although the example PLC 12 is shown, the invention is applicable to any suitable interface (e.g., controller; processor; PC; a number of relays) to the selected power pedestal 4 (e.g., contactor 50 thereof). As but one example alternative, the PLC 12 may be replaced by the site controller 24 or by another suitable PC.

In response to the signal 46, the example PLC 12 outputs a signal 48 to the contactor 50 of the selected power pedestal (e.g., 4A) to turn on an indicator light 52 (e.g., without limitation, red) atop that power pedestal to signal the user which power pedestal was actually selected. The contactor 50, when energized, is structured to enable power output from the corresponding power pedestal 4 for the inputted time duration 14 responsive to the corresponding output 13 of the PLC 12.

In addition to the indicator light 52, the power pedestal 4 may, for example, have another light 54 that is illuminated whenever the power line input 58 is energized and, thus, is independent of the indicator light 52 and independent of the power output receptacles 56 thereof being enabled. This other light 54 is hard wired from the power line input 58 to the pedestal 4A. Preferably, a suitable circuit interrupter (not shown) is employed between the power line input 58 and the light 54. In contrast, when the indicator light 52 is on, the power pedestal output receptacles 56 are energized. Hence, the indicator light 52, when illuminated, indicates when the power output from the corresponding power pedestal 4 is enabled.

Next, at 59, the processor 8 displays a prompt on the display 43 for the user to verify and confirm that the desired power pedestal (e.g., 4A) was, in fact, chosen. In response, the user physically verifies that the desired power pedestal was chosen via the indicator light 52 being on and confirms the same via the keypad 44 (e.g., without limitation, by selecting yes or no). If a no input is read from the keypad 44, at 60, then, the processor 8 sends, at 61, a signal 46′ through the network hub 22 to the PLC 12. In response to this signal, the example PLC 12 outputs a signal 48′ to the contactor 50 of the selected pedestal (e.g., 4A) to de-energize the contactor 50. This turns power off to the number of power output receptacles 56 and the indicator light 52 of the selected power pedestal. Then, step 42 is repeated, in order to permit the user to select a different power pedestal.

Otherwise, if a yes input is read from the keypad 44, at 60, then, at 62, the processor 8 displays a prompt on the display 43 for the user to enter the desired time duration via the keypad 44 for the selected power pedestal (e.g., 4A) to be energized (e.g., without limitation, in one-hour increments). In response, the user enters the desired time duration via the keypad 44. Next, at 64, the processor 8 reads the desired time duration from the keypad 44 and responsively sends, at 66, a signal 67 to a receipt printer 68, which responsively prints a receipt 69 (shown in phantom line drawing) showing the charge or debit (e.g., proportional to the desired time for the selected power pedestal to be enabled), the time (or time and date) that the selected power pedestal (e.g., 4A) was turned on (e.g., without limitation, as obtained from a suitable clock (not shown)), and the time (or time and date) that it will be shut off (e.g., the time that the selected power pedestal was turned on plus the desired time duration for the power pedestal to be enabled). Then, at 70, the processor 8 cooperates with the site controller 24, in a manner that is well known, to initiate the actual charge or debit for the transaction.

Next, at 72, the processor 8 initializes a timer 73 corresponding to the selected power pedestal (e.g., 4A) with the desired time duration of step 64. Then, at 74, the processor 8 checks the timer 73 to determine if it has expired. If not, then after a suitable interval at 76, the timer 73 is periodically rechecked at 74. Otherwise, if the timer 73 expired at 74, then, at 78, the processor 8 sends the signal 46′ through the network hub 22 to the PLC 12. In response to this signal 46′, the example PLC 12 outputs the signal 48′ to the contactor 50 of the selected power pedestal (e.g., 4A) to de-energize the contactor 50. This turns power off to the number of power output receptacles 56 and extinguishes the indicator light 52 of the selected power pedestal. Thus, the indicator light 52 indicates when the power output from the corresponding power pedestal 4 is enabled and the corresponding timer 73 has not expired.

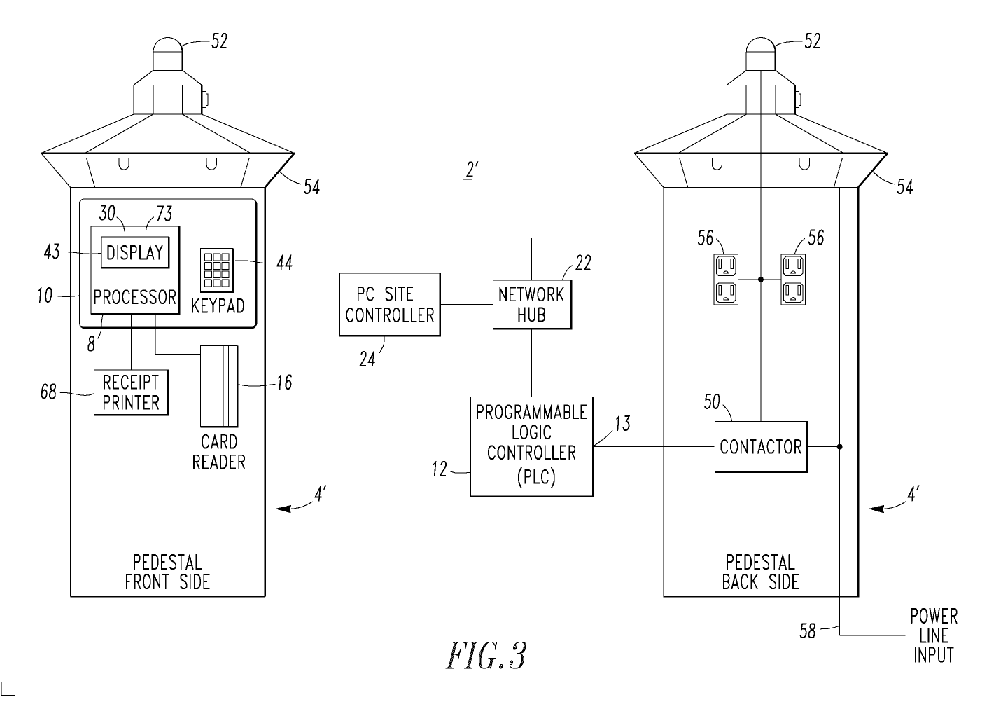

It will be appreciated that the other power pedestals 4B,4C may be the same as or similar to the power pedestal 4A, and that the routine 30 may interface with the other power pedestals 4B,4C in a similar manner as has been described with power pedestal 4A. It will also be appreciated that the PLC 12 interfaces to the other power pedestals 4B,4C in a similar manner as was discussed above in connection with the first power pedestal 4A. Alternatively, some or all of the above logic and hardware may be incorporated into a number of the power pedestals 4 to form a number of stand-alone payment pedestals/kiosks. Such a system 2′ and a power pedestal 4′ are shown in FIG. 3.

### EXAMPLE 3

As shown with the power pedestal 4B of FIG. 1B, this may be, for example and without limitation, a marina power pedestal including a pedestal member 80 having a base 82 structured to be fixed to a platform, such as, for example and without limitation, a dock pier 84 (shown in phantom line drawing) and an enclosure 86 extending generally vertically from the base 82. Although a dock pier 84 is disclosed, the platform may be any suitable platform, such as a concrete platform member at a recreational vehicle (RV) park. Thus, the power pedestals 4 may be vehicle (e.g., without limitation, RV) power pedestals. The power pedestal base 82 includes a plurality of openings 88 structured to receive a plurality of fasteners (not shown) to fix the base 82 to the example dock pier 84 or other suitable platform.

### EXAMPLE 4

The user interface device 10 of the payment kiosk 6 of FIG. 1A may include some or all of the display 43, keypad 44, card reader 16 and receipt printer 68. As a minimum, the user interface device 10 includes any suitable input device, such as the example keypad 44, and any suitable output device, such as the example display 43 and/or the example printer 68. The display 43 may preferably be structured to display the inputted time duration 14 and/or the time remaining before the timer 73 expires.

### EXAMPLE 5

FIG. 3 shows a system 2′ including a stand-alone payment power pedestal/kiosk 4′. The power pedestal/kiosk 4′ is similar to the power pedestal 4 of FIG. 1 except that the processor 8 and user interface device 10 (including the example card reader 16 and optional receipt printer 68) of the payment kiosk 6 are now part of the power pedestal/kiosk 4′. The system 2′, like the system 2, includes the example PC site controller 24, the network hub 22 and the PLC 12.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A system for enabling power output from a power pedestal, said system comprising:
a number of power pedestals;
a processor;
a user interface device cooperating with said processor to input a time duration to power one of said number of power pedestals; and
an interface to said number of power pedestals, said interface cooperating with said processor and being structured to enable power output from said one of said number of power pedestals for said inputted time duration.

2. The system of claim 1 wherein said number of power pedestals is a plurality of power pedestals.

3. The system of claim 1 wherein said number of power pedestals is one power pedestal.

4. The system of claim 1 wherein said user interface device comprises a display and a user input device; wherein said user input device is structured to input said time duration; and wherein said display is structured to display said inputted time duration.

5. The system of claim 1 wherein said processor comprises a timer and a routine; wherein said routine is structured to initialize said timer with said inputted time duration; wherein said timer is structured to expire after said inputted time duration has elapsed; and wherein said routine is further structured to responsively disable said power output from said one of said number of power pedestals after said timer has expired.

6. The system of claim 5 wherein said routine is further structured to output a signal through said interface to disable said power output from said one of said number of power pedestals responsive to said timer being expired.

7. A system for enabling power output from a power pedestal, said system comprising:
a number of power pedestals;
a card reader structured to receive credit or debit card information from a credit or debit card;
a first interface to another system structured to approve a transaction based upon said credit or debit card information;
a processor cooperating with said card reader and said first interface to initiate and receive approval of said transaction from said another system;
a user interface device cooperating with said processor to input a time duration to power one of said number of power pedestals responsive to said received approval; and
a second interface to said number of power pedestals, said second interface cooperating with said processor and being structured to enable power output from said one of said number of power pedestals for said inputted time duration.

8. The system of claim 7 wherein said processor is a first processor; wherein said first interface comprises a network hub communicating with a second processor; and wherein said second processor is structured to verify said credit or debit card information and send a signal back to said first processor through said network hub to confirm said transaction.

9. The system of claim 8 wherein said first processor is structured to cooperate with said second processor to initiate a charge or debit for said transaction.

10. The system of claim 7 wherein said second interface comprises a programmable logic controller including an output; and wherein said one of said number of power pedestals comprises a number of power output receptacles and a contactor, said contactor being structured to enable power output from said one of said number of power pedestals for said inputted time duration responsive to the output of said programmable logic controller.

11. The system of claim 10 wherein said second interface further comprises a network hub communicating with said programmable logic controller.

12. The system of claim 7 wherein said one of said number of power pedestals comprises an indicator structured to indicate when said power output from said one of said number of power pedestals is enabled.

13. The system of claim 12 wherein said one of said number of power pedestals further comprises a light structured to be illuminated regardless whether said one of said number of power pedestals is enabled.

14. The system of claim 12 wherein said user interface device comprises a display and a user input device; and wherein said display and said user input device cooperate to select said one of said number of power pedestals and to confirm that said selected one of said number of power pedestals was enabled.

15. The system of claim 7 wherein said user interface device comprises a display and a user input device; and wherein said display and said user input device cooperate to enable a user to input said time duration and to display said inputted time duration.

16. The system of claim 7 wherein said user interface device comprises a display and a user input device; and wherein said display and said user input device cooperate to enable a user to input said time duration as a number of hours.

17. The system of claim 7 wherein said user interface device comprises a printer and a user input device; wherein said processor is structured to input said time duration from said user input device and responsively send a signal to said printer; and wherein said printer is structured to print a receipt responsive to said signal, said receipt including a charge or debit operatively associated with said transaction, a first time that said one of said number of power pedestals was enabled to output power, and a later second time that said one of said number of power pedestals would be disabled to output power.

18. The system of claim 7 wherein said processor comprises a timer and a routine; wherein said routine is structured to initialize said timer with said inputted time duration; wherein said timer is structured to expire after said inputted time duration has elapsed; and wherein said routine is further structured to responsively disable power output from said one of said number of power pedestals after said timer has expired.

19. The system of claim 18 wherein said routine is further structured to output a signal through said second interface to disable power output from said one of said number of power pedestals responsive to said timer being expired.

20. The system of claim 18 wherein said one of said number of power pedestals comprises an indicator structured to indicate when said power output from said one of said number of power pedestals is enabled and said timer has not expired, said indicator being disabled when said timer has expired.

21. The system of claim 7 wherein said one of said number of power pedestals comprises a pedestal member comprising a base structured to be fixed to a platform, and an enclosure extending from said base.

22. The system of claim 21 wherein said enclosure is a housing extending generally vertically from said base.

23. A method of enabling power output from a power pedestal, said method comprising:
employing a number of power pedestals;
inputting a time duration to power one of said number of power pedestals; and
enabling power output from said one of said number of power pedestals for only said inputted time duration.

24. The method of claim 23 further comprising
receiving credit card or debit card information from a credit card or a debit card, respectively;
approving a transaction based upon said credit card or debit card information; and
charging or debiting said credit card or said debit card, respectively, as a function of said inputted time duration.
